(19) United States
(12) Patent Application Publication
(10) Pub. No.: US 2017/0305669 A1
(43) Pub. Date: Oct. 26, 2017

(54) HIGH-EFFICIENCY STORAGE SYSTEM

(71) Applicant: SEMTEK CORPORATION CO., LTD., NEW TAIPEI CITY (TW)

(72) Inventors: SHAO-TING TSAI, NEW TAIPEI CITY (TW); YU-SHAN HUANG, NEW TAIPEI CITY (TW)

(21) Appl. No.: 15/138,230

(22) Filed: Apr. 26, 2016

(51) Int. Cl. B65G 1/137; B65G 1/04; B65G 1/10

(52) U.S. Cl. CPC B65G 1/1373; B65G 1/10; B65G 1/0478; B65G 1/0485

(57) ABSTRACT

A high-efficiency storage system includes: a warehouse area, having grid spaces arranged closely with each other into an a×b matrix, and a and b being positive integers greater than 1; plural containing members disposed in the grid spaces for containing objects respectively; plural moving members for moving the containing members in the warehouse area; and a control device, telecommunicatively coupled to the moving members, for controlling the movement of the moving members. The effect of managing a warehouse automatically can be achieved by connecting the control device to the moving members telecommunicatively, so as to reduces the walkway space originally used for transporting goods and increase the storage space, and the warehouse area come with a matrix design, so that the storage space is utilized effectively, and the remaining usable spaces in the warehouse area can be fully used.

### TECHNICAL FIELD

The present invention relates to the field of warehouses, and more particularly to a high-efficiency storage system with an automation design that utilizes the space originally used for walkways as a storage space.

### BACKGROUND

Warehouse logistics use self-built or rental warehouses or sites for storing safekeeping, loading/unloading, and distributing goods. As the trading industry blooms, the warehouse logistics industry is driven up.

At present, the warehouse logistics generally adopts a three-dimensional warehouse for warehouse management, and several shelves are installed and provided for storing and accessing goods manually or driving a forklift among the alleys. With reference to FIG. 1 for a schematic view of a conventional three-dimensional warehouse, the warehouse 2 includes a plurality of shelves 21 and a plurality of walkways 22 constructed therein, and each of the walkways 22 is arranged between the shelves 21. When use, a staff has to remove a customer's desired object from one of the shelves 21 or store a customer's desired object onto one of the shelves 21, and thus requiring the staff or a forklift to enter into the warehouse 2 to place or search the customer's desired object among the shelves 21, so that an error of obtaining the wrong material may occur and the application is inconvenient. In addition, the walkways occupy much interior space, so that the warehouse cannot store more objects. Although some of the manufacturers use mechanical arms to reduce the time for the staff to store and search the objects, yet the mechanical parts of the mechanical arms also occupy much storage space, and they are precision mechanical parts and their repair and maintenance are relatively more difficult.

In view of the aforementioned problems of the conventional storage system, the inventor of the present invention based on years of experience in the related industry to conduct extensive researches and experiments and finally developed a high-efficiency storage system to overcome the problems of the prior art.

### SUMMARY

Therefore, it is a primary objective of the present invention to provide a high-efficiency storage system that eliminates the space originally used for walkways or moving the mechanical arms by an automation design to increase the storage space and lower the storage cost and uses an automatic control system to control the input and output of objects and reduce human errors.

To achieve the aforementioned and other objectives, the present invention provides a high-efficiency storage system, comprising: a warehouse area, having a plurality of grid spaces arranged closely with one another to form an a×b matrix, and a and b being positive integers greater than 1, and the grid spaces being composed of a plurality of containing areas and at least one depleted area, and the quantity of the containing areas being greater than the quantity of depleted areas, and the warehouse area having at least one goods input/output port formed on a side of the warehouse area; a plurality of containing members, disposed in the containing areas respectively, for containing objects; a plurality of moving members, coupled to the containing members respectively, for moving the containing members in the warehouse area to change the relative position of the containing areas and the depleted area; and a control device, telecommunicatively coupled to the moving members, for controlling the movement of the moving members;

wherein, the control device adjusts the relative position of the containing areas and the depleted area to move one of the containing members in the warehouse area to the goods input/output port.

Wherein, the warehouse area further comprises a plurality of rails, and the moving members slide on the rails, and the rails are coupled to one another. In addition, the rails are arranged on the same plane represented by X and Y axes, and some of the rails are disposed at the boundary of the warehouse area to form a circular arrangement, and the remaining rails are disposed at a middle area of the circular arrangement and all of the remaining rails are arranged in a direction parallel to the X-axis or all of the remaining rails are arranged in a direction parallel to the Y-axis. Therefore, the rails can limit the moving path of the containing members to reduce the load of the control device when computing the moving path.

Preferably, the present invention further comprises a carrying device, installed on an outer side of the goods input/output port, and provided for putting the objects into the containing members or removing the objects from the containing members, and the carrying device having at least one rail, a carrying board and a mechanical arm, and the carrying board sliding on the rail and being used for carrying a desired inputting object or a removed object, and the mechanical arm being installed on a side of the carrying board and provided for removing or inputting the object, and the rail being installed along the Z-axis, and the Z-axis being perpendicular to the X-axis and the Y-axis. With the installation of the carrying device, a staff can retrieve an object from a containing member at a higher level or store an object into a containing member at a higher level, so as to improve the efficiency and convenience.

Preferably, the carrying device further has a temporary storage area for storing a plurality of removed objects. If several objects can be retrieved at a time, the pickup efficiency will be improved, and the staff no longer needs to remove the object from the carrying board to continue the next operation after the carrying device has retrieved an object.

Preferably, the present invention further comprises a communication unit and a mobile device, and the communication unit being telecommunicatively coupled to the mobile device and the control device, and the mobile device being used for operating and controlling the control device from a remote end to improve the convenience of a staff working in the warehouse.

In summation, the control device is telecommunicatively coupled to the moving members to achieve the effects of managing the warehouse automatically, reducing the walkway space originally used for transporting the goods, and increasing the storage space. With the design of the depleted area and the containing areas, the containing members may be moved to the goods input/output port by moving the depleted area and the containing areas with respect to one another, so as to facilitate the operating flow for storing and retrieving goods. As a result, the storage space is utilized effectively, and the usable spaces of the warehouse area will not be scattered, and the remaining usable spaces can be fully utilized.

### BRIEF DESCRIPTION OF THE DRAWINGS

FIG. 1 is a schematic view of a conventional three-dimensional warehouse;

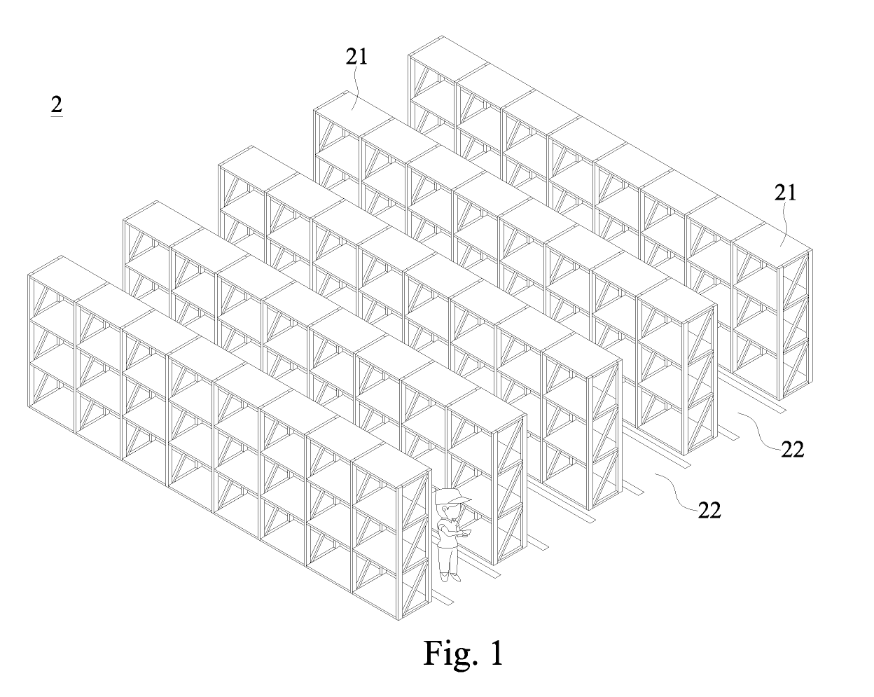

FIG. 2 is a schematic view of a first embodiment of the present invention;

FIG. 3 is a schematic view of a second embodiment of the present invention;

FIG. 4 is a first schematic view showing the movement of the second embodiment of the present invention;

FIG. 5 is a second schematic view showing the movement of the second embodiment of the present invention;

FIG. 6 is a third schematic view showing the movement of the second embodiment of the present invention;

FIG. 7 is a fourth schematic view showing the movement of the second embodiment of the present invention;

FIG. 8 is a fifth schematic view showing the movement of the second embodiment of the present invention;

FIG. 9 is a schematic view of a third embodiment of the present invention;

FIG. 10 is a schematic view of a fourth embodiment of the present invention; and

FIG. 11 is a schematic view of a fifth embodiment of the present invention.

### DESCRIPTION OF THE PREFERRED EMBODIMENTS

The above and other objects, features and advantages of this disclosure will become apparent from the following detailed description taken with the accompanying drawings.

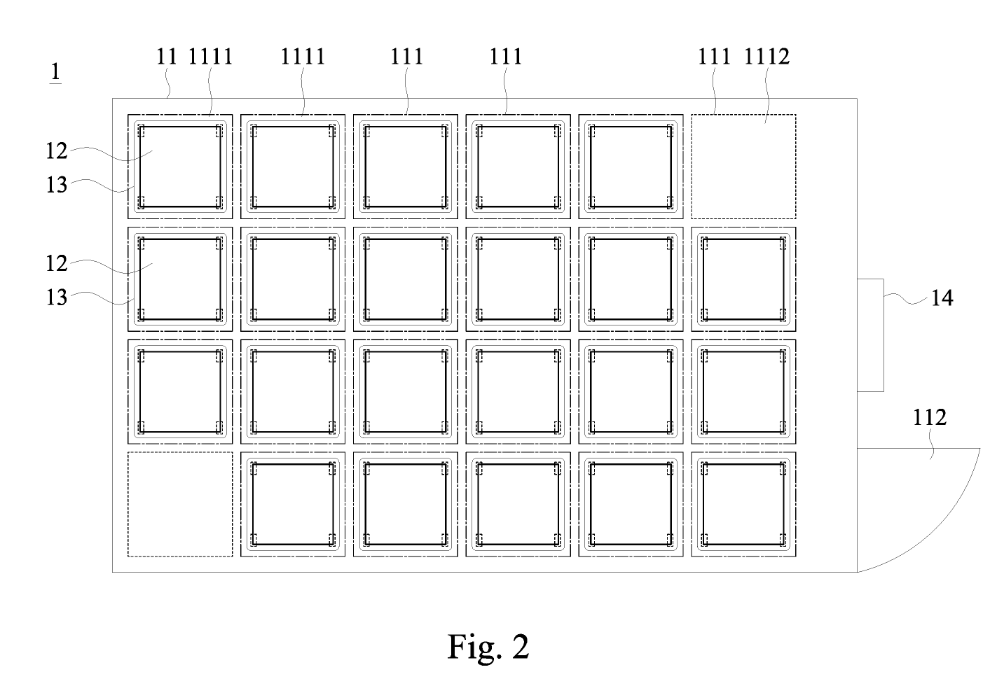

With reference to FIG. 2 for a schematic view of a high-efficiency storage system 1 in accordance with the first embodiment of the present invention, the high-efficiency storage system 1 comprises a warehouse area 11, a plurality of containing members 12, a plurality of moving members 13 and a control device 14.

The warehouse area has a plurality of grid spaces arranged closely with each other into an a×b matrix, wherein a and b are positive integers greater than 1, and the grid spaces 111 are composed of a plurality of containing areas 1111 and at least one depleted area 1112, and the quantity of the containing areas 1111 must be greater than the quantity of the depleted areas 1112, and at least one goods input/output port 112 is formed on a side of the warehouse area 11. The containing members 12 are provided for accommodating objects and disposed in the containing areas 1111 respectively. The moving members 13 are coupled to the containing members 12 respectively and provided for moving the containing members 12 in the warehouse areas 11 to change the relative position of the containing areas 1111 and the depleted area 1112. In this embodiment, the moving members 13 are bases with wheels, and each of the containing members 12 is placed on the base before moving. The control device 14 is telecommunicatively coupled to the moving members 13 and provided for controlling the movement of the moving members 13.

The warehouse areas 11 of the present invention are arranged into a matrix to achieve the effect of utilizing the space effectively, and the positions of the containing areas 1111 and the depleted area 1112 may be switched, and the containing members 12 are moved to the goods input/output port 112 to facilitate the warehouse staff's operation. Since the moving path of the containing members 12 is controlled by the control device 14, therefore the control device 14 will compute the optimal path to move the containing member 12 to the goods input/output port 112 to improve the efficiency of storing and retrieving goods. The more the depleted areas 1112, the faster the speed of moving the containing members 12 to the goods input/output port 112. However, if the quantity of the depleted areas 1112 is too many, and the quantity of the grid spaces 111 is fixed, then the quantity of the containing areas 1111 will be decreased to affect the total storage space. In this embodiment, the quantity of depleted areas 1112 must be smaller than or equal to a quarter of the total quantity of the grid spaces 111, so that a balance between the moving speed and the storage space can be achieved. Although there is no particular upper limit of the quantity of grid spaces 111, the maximum matrix should not exceed 80×80 (in other words, a and b should not exceed 80) in order to maintain a goods storing/retrieving speed, or else the goods storing/retrieving speed will be lower than the expected speed. If the matrix is too large, the daily repair and maintenance will be difficult. In this embodiment, there is only one goods input/output port 112. Of course, the present invention may have several goods input/output ports 112 for taking out objects from different positions at the same time.

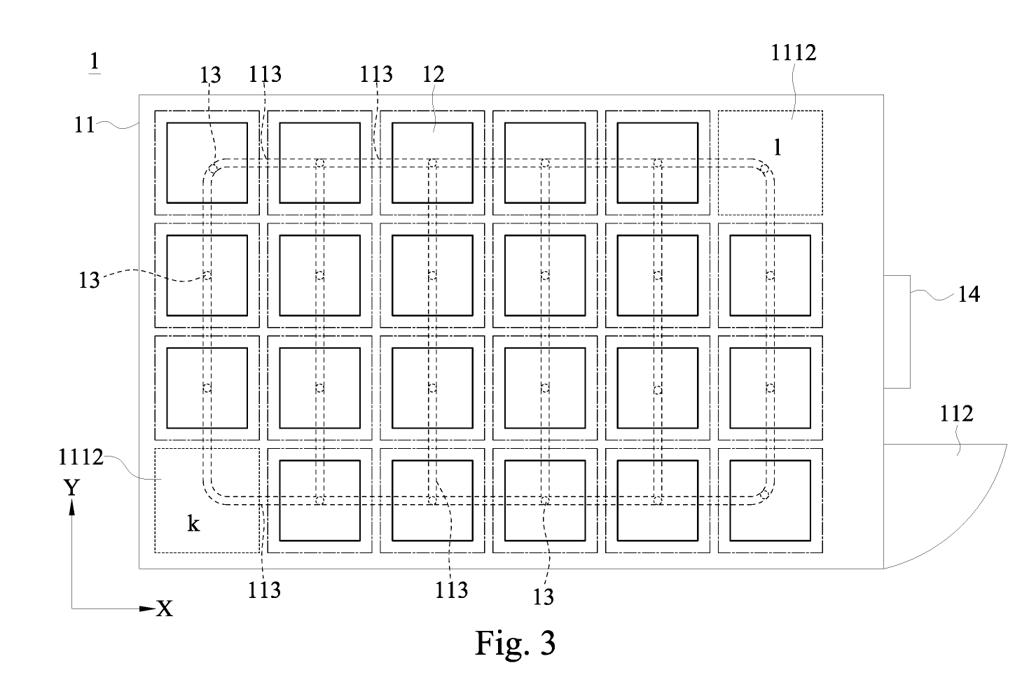

With reference to FIGS. 3 to 8 for a schematic view of a high-efficiency storage system and the first to fifth schematic views of moving the high-efficiency storage system in accordance with the second embodiment of the present invention respectively, the high-efficiency storage system of this embodiment is substantially the same as that of the first embodiment, except that the warehouse area 11 of this embodiment further comprises a plurality of rails 113, and the moving members 13 slide on the rails 113, wherein the rails 113 are coupled to one another. In this embodiment, the rails 113 are arranged on the same plane, wherein the plane is represented by the X and Y axes, and some of the rails 113 are disposed at the boundary of the warehouse area 11 and arranged in a circular shape, and the remaining rails 113 are disposed in the middle area of the circular shape, and all of them are arranged in a direction parallel to the X-axis or all of them are arranged in a direction parallel to the Y-axis, and the remaining rails 113 of this embodiment are arranged in a direction parallel to the Y-axis, and the remaining components of this embodiment are the same as those of the first embodiment and thus will not be described again. The moving path of some of the containing members 12 can be controlled to reduce the load of the control device 14 for computing the optimal path, and indirectly improve the service life of the present invention. In addition, the rails 113 may be installed on floor or at ceiling, and the invention is not limited to any particular arrangement. In this embodiment, the moving members 13 are latched to the rails 113 for sliding thereon, so that the containing members 12 may be moved according to the path limited by the rails 113.

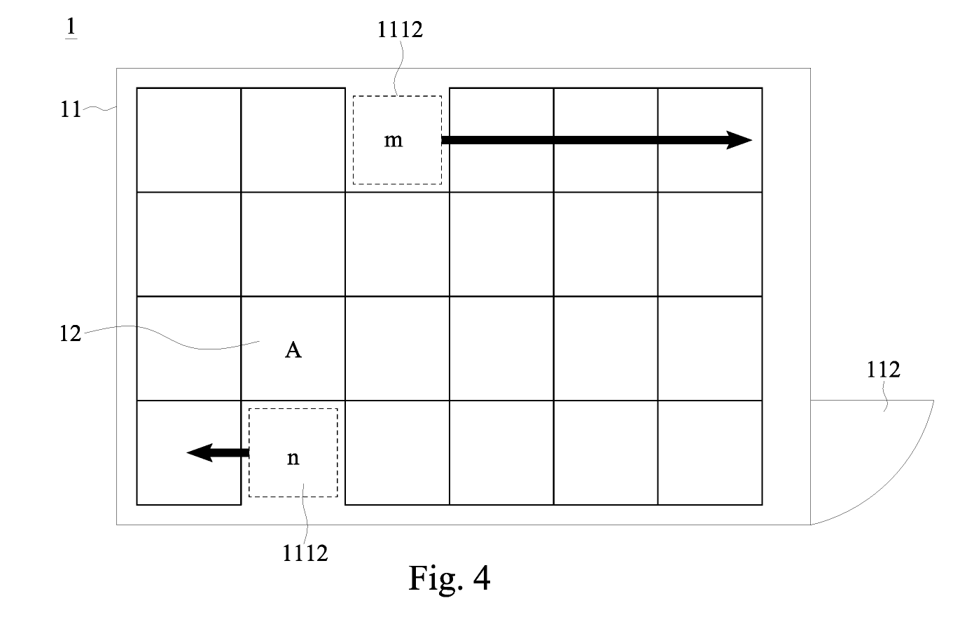

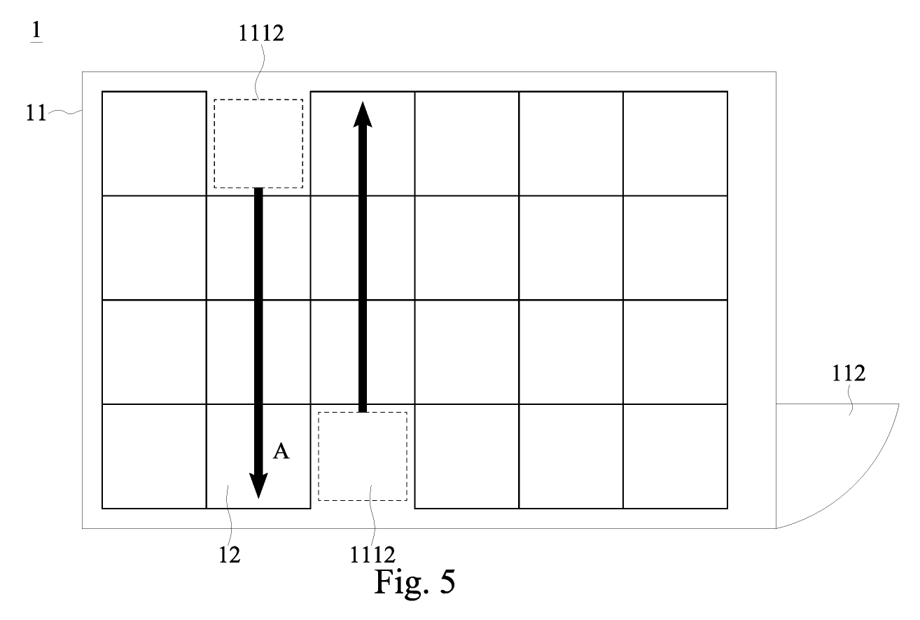

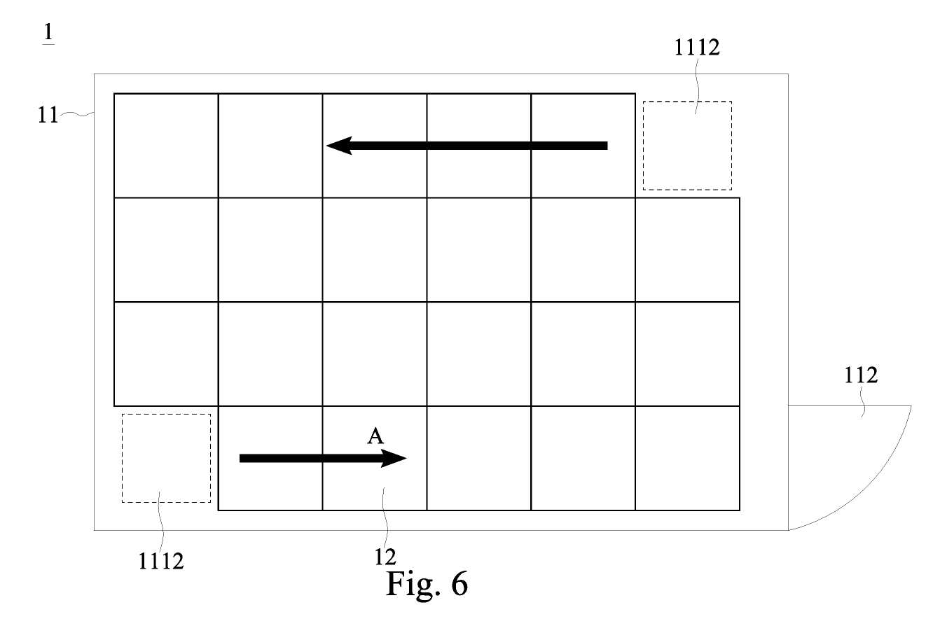

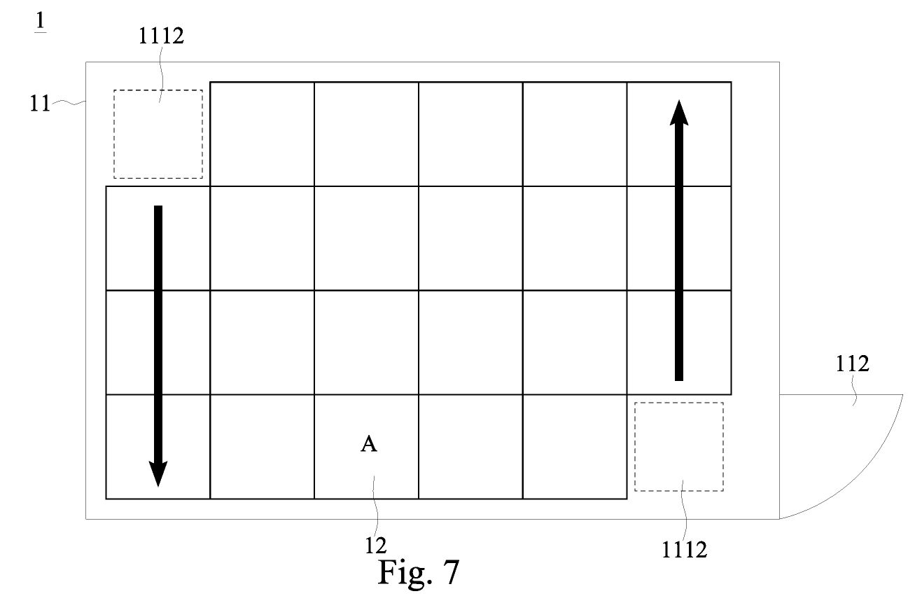

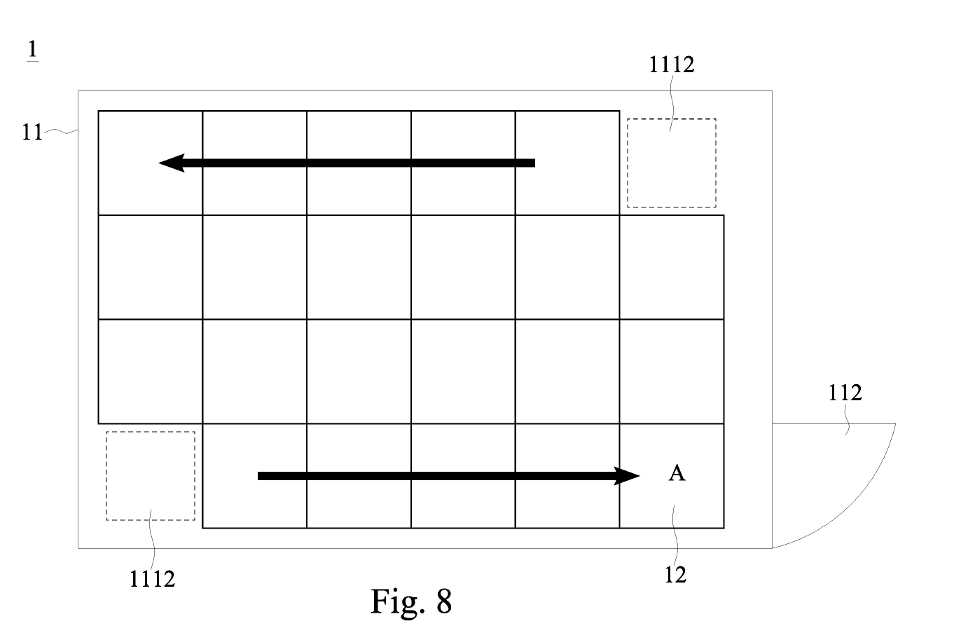

At the initial status as shown in FIG. 3, this embodiment has a plurality of depleted areas 1112. If an object is retrieved from the containing member 12 with a serial number A, some of the containing members 12 will be moved first, so that the depleted areas 1112 are moved from the positions 1 and k (of FIG. 3) to the positions m and n (of FIG. 4), and the whole column of the containing members 12 (where the containing member 12 with the serial number A is situated) is moved downward, and the whole column row of the containing members 12 on the right of the containing member 12 with the serial number A is moved upward, so as to define the condition as shown in FIG. 5. When the containing member 12 with the serial number A is situated on the same straight line of the goods input/output port 112, the steps as shown in FIGS. 6 and 7 can be repeated to move the containing member 12 with the serial number A to the goods input/output port 112 through the circular rails 113, so as to facilitate warehouse staffs to perform the operation of retrieving or storing goods as shown in FIG. 8.

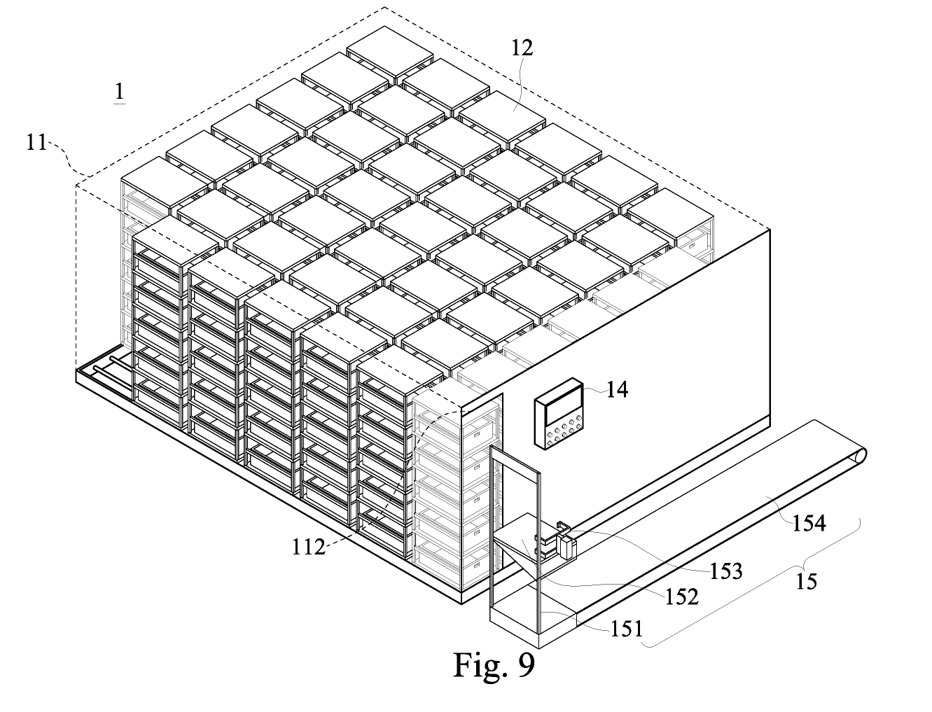

With reference to FIG. 9 for a schematic view of a high-efficiency storage system in accordance with the third embodiment of the present invention, this embodiment is substantially the same as the second embodiment, except that each of the containing members 12 of this embodiment comes with a multi-layer design for accommodating different objects. In addition, the present invention further comprises a carrying device 15 installed on an outer side of the goods input/output port 112 for storing an object into the containing members 12 or removing an object from the containing members 12, and the carrying device 15 has at least one rail 151, a carrying board 152 and a mechanical arm 153, wherein the carrying board 152 slides on the rail 151 and carries the desired storing or removing object, and the mechanical arm 153 is installed on a side of the carrying board 152 for removing or storing an object, and the rail 151 is installed along the Z-axis, wherein the Z-axis is perpendicular to the X-axis and the Y-axis. In addition, the carrying device 15 further has a temporary storage area 154 for storing a plurality of removed object. The remaining components are the same as those of the second embodiment, and thus will not be repeated.

With the carrying device 15, the labor can be saved further effectively, and the machine is provided for removing an object from the containing members 12 or storing the object into the containing members 12, and the temporary storage area 154 is provided for storing a plurality of objects to expedite the speed of storing or removing objects by the carrying device 15, and the temporary storage area 154 may be a conveyor belt capable of moving the object to any position of the temporary storage area 154 and temporarily storing a plurality of objects to be processed.

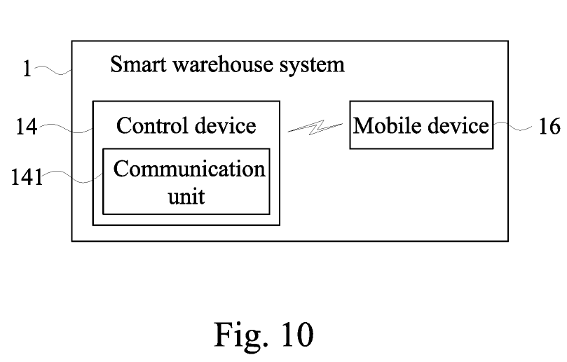

With reference to FIG. 10 for a block diagram of a high-efficiency storage system in accordance with the fourth embodiment of the present invention, the high-efficiency storage system further comprises a communication unit 141 and a mobile device 16, and the communication unit 141 is installed in the control device 14 and telecommunicatively coupled to the mobile device 16 and the control device 14, and the mobile device 16 is provided for operating and controlling the control device 14 from a remote end. With the remove control of the mobile device 16, the present invention improves the speed of storing and retrieving goods. In practical applications, the temporary storage area and the counter are generally located at different positions, so that the control device 14 will be situated at a position with a distance from the goods receiving and pickup counter. Without the aforementioned remote control measure, the pickup operation requires the warehouse staff to walk back and forth between the control device 14 and the counter, and thus wastes time. With the installation of the mobile device 16 of the present invention, the warehouse staff may talk with a customer at the counter while using the mobile device 16 to perform the pickup operation. After the pickup is completed, the warehouse staff may deliver the object to the customer directly without the need of walking to the control device 14 to input the instruction before returning to the counter. With the installation of the mobile device 16, the pickup operation becomes faster and easier.

The present invention comes with an intense and automatic design, so that it can be installed at different sites such as a warehouse or a freezer, or even a storage area of a truck to improve the staff's efficiency of retrieving or storing objects and also utilize spaces effectively to avoid unnecessary waste of space utilization. In addition, the size of the containing members is not restricted, and simply depends on the size of the stored objects. The stored object may be as small as a general daily supply, or as large as a motor vehicle. With the matrix design, the walkway space is integrated into the storage space to increase the storage space substantially, and the length of the conventional shelf is too long, such that the whole plane of the front of the shelf is used as the goods input/output port. On the other hand, the design of the present invention decreases the area of the goods input/output port significantly to increase the available spaces for other uses significantly.

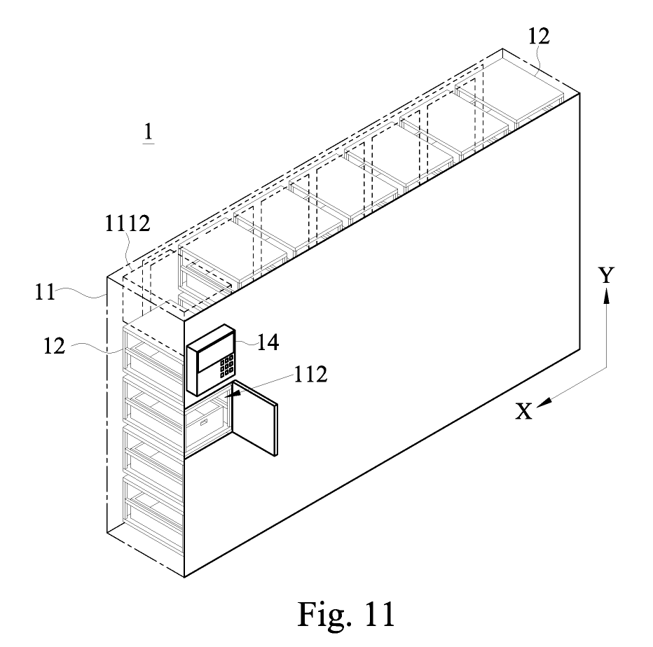

With reference to FIG. 11 for a schematic view of a high-efficiency storage system in accordance with the fifth embodiment of the present invention, the present invention may be used for the self-service locker at a station or an airport, and users may confirm the position of a containing member 12 without storing any object from a screen of the control device 14, so that a button on the control device 14 may be selected to move any one of the containing member 12 without storing any object to the goods input/output port 112, and a user may put an object into such containing member 12 for storage. After storing the object, the user may set a password or an instruction to the containing member 12. In addition, the goods input/output port 112 has a movable door. For pickup, the user simply needs to input the correct password or instruction to the control device 14 to move the containing member 12 to the goods input/output port 112 and open the movable door, so that the user can take out the stored object, so as to improve the security of storage. If the movable door is transparent, and the user has stored an object, the control device 14 will move the containing member 12 containing the object to another place, so that the depleted area 1112 is switched to the goods input/output port 112 to prevent others from seeing the content of the containing members 12 through the transparent movable door, so as to avoid theft and protect privacy. In this embodiment, the whole wall of the goods input/output port may be made of a double-sided mirror or an electrically conductive glass, so that the location of the object in which containing member 12 may be known easily at home or in office as long as the light or power is turned on, and it helps users to find the location of a desired retrieving object and facilitates the operation of the control device 14.

What is claimed is:

1. A high-efficiency storage system, comprising:
a warehouse area, having a plurality of grid spaces arranged closely with one another to form an a×b matrix, and a and b being positive integers greater than 1, and the grid spaces being composed of a plurality of containing areas and at least one depleted area, and the quantity of the containing areas being greater than the quantity of depleted areas, and the warehouse area having at least one goods input/output port formed on a side of the warehouse area;
a plurality of containing members, disposed in the containing areas respectively, for containing objects;
a plurality of moving members, coupled to the containing members respectively, for moving the containing members in the warehouse area to change the relative position of the containing areas and the depleted area; and
a control device, telecommunicatively coupled to the moving members, for controlling the movement of the moving members;
wherein, the control device adjusts the relative position of the containing areas and the depleted area to move one of the containing members in the warehouse area to the goods input/output port.

2. The high-efficiency storage system according to claim 1, wherein the warehouse area further comprises a plurality of rails, and the moving members slide on the rails, and the rails are coupled to one another.

3. The high-efficiency storage system according to claim 2, wherein the rails are arranged on the same plane represented by X and Y axes, and some of the rails are disposed at the boundary of the warehouse area to form a circular arrangement, and the remaining rails are disposed at a middle area of the circular arrangement and all of the remaining rails are arranged in a direction parallel to the X-axis or all of the remaining rails are arranged in a direction parallel to the Y-axis.

4. The high-efficiency storage system according to claim 3, further comprising a carrying device, installed on an outer side of the goods input/output port, and provided for putting the objects into the containing members or removing the objects from the containing members, and the carrying device having at least one rail, a carrying board and a mechanical arm, and the carrying board sliding on the rail and being used for carrying a desired inputting object or a removed object, and the mechanical arm being installed on a side of the carrying board and provided for removing or inputting the object, and the rail being installed along the Z-axis, and the Z-axis being perpendicular to the X-axis and the Y-axis.

5. The high-efficiency storage system according to claim 4, wherein the carrying device further has a temporary storage area for storing a plurality of removed objects.

6. The high-efficiency storage system according to claim 1, further comprising a communication unit and a mobile device, and the communication unit being telecommunicatively coupled to the mobile device and the control device, and the mobile device being used for operating and controlling the control device from a remote end.

7. The high-efficiency storage system according to claim 2, further comprising a communication unit and a mobile device, and the communication unit being telecommunicatively coupled to the mobile device and the control device, and the mobile device being used for operating and controlling the control device from a remote end.

8. The high-efficiency storage system according to claim 3, further comprising a communication unit and a mobile device, and the communication unit being telecommunicatively coupled to the mobile device and the control device, and the mobile device being used for operating and controlling the control device from a remote end.

9. The high-efficiency storage system according to claim 4, further comprising a communication unit and a mobile device, and the communication unit being telecommunicatively coupled to the mobile device and the control device, and the mobile device being used for operating and controlling the control device from a remote end.

10. The high-efficiency storage system according to claim 5, further comprising a communication unit and a mobile device, and the communication unit being telecommunicatively coupled to the mobile device and the control device, and the mobile device being used for operating and controlling the control device from a remote end.

11. The high-efficiency storage system according to claim 6, wherein each of the containing members comes with a multi-layer design for containing different objects.

12. The high-efficiency storage system according to claim 7, wherein each of the containing members comes with a multi-layer design for containing different objects.

13. The high-efficiency storage system according to claim 8, wherein each of the containing members comes with a multi-layer design for containing different objects.

14. The high-efficiency storage system according to claim 9, wherein each of the containing members comes with a multi-layer design for containing different objects.

15. The high-efficiency storage system according to claim 10, wherein each of the containing members comes with a multi-layer design for containing different objects.
